(19) United States
(12) Patent Application Publication
(10) Pub. No.: US 2009/0311397 A1
(43) Pub. Date: Dec. 17, 2009

(54) PROCESS FOR EDIBLE PROTEIN EXTRACTION FROM CORN GERM

(75) Inventors: Paul J. Whalen, Rapid City, SD (US); Theron Cooper, Volga, SD (US); Scott Lucas, Wichita, KS (US)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: ICM, Inc., Colwich, KS (US)

(21) Appl. No.: 12/486,554

(22) Filed: Jun. 17, 2009

Related U.S. Application Data
(60) Provisional application No. 61/073,357, filed on Jun. 17, 2008.

(51) Int. Cl. A23J 1/12

(52) U.S. Cl. 426/436

(57) ABSTRACT

A process for extraction of edible protein from corn germ. The process includes providing a defatted corn germ with a fat concentration of less than about 5% by weight, milling the corn germ to a granulation of less than about 100 US mesh at less than 180° F., preparing a slurry from the milled corn germ, extracting a edible protein solution from the slurry, recovering the edible protein by precipitating agents (ethanol, acids), and drying the edible protein. The resulting food is 80% to 90% protein.

### REFERENCE TO RELATED APPLICATION

This application claims priority to U.S. Provisional Application No. 61/073,357, which was filed on Jun. 17, 2008, the contents of which are incorporated herein by reference.

### FIELD OF THE INVENTION

The invention relates generally to grain processing. More particularly, the invention relates to a process for extracting edible protein from corn germ.

### BACKGROUND OF THE INVENTION

Corn (Maize) for human food purposes is commercially processed mainly for its starch and oil content with the remaining residual material going to animal feed. Whole kernel corn is approximately 9% protein, with 82% residing in the endosperm and approximately 18% residing in the germ.

Two of the primary methods used in processing corn are the wet milling and dry milling processes (Corn: Chemistry & Technol, 2003). Wet milling separates the corn components by steeping the corn kernel in an excess of water with sulfur dioxide to a high moisture of about 45%. The desired, high value end products from the wet milling process are the starch and the oil from the germ. The spent germ cake, steep materials, gluten, and, any fibrous residual material, including the corn hull, are combined into animal feed commonly known as corn gluten feed (germ) and corn gluten meal (starch washing and fiber). Corn dry-milling is the other major process which fractionates food grade products out of the whole kernel. As the name implies, the kernel is run relatively ‘dry’ compared to a wet mill process. To assist processing the corn, moisture may be adjusted from 14% to only 20%. The dry mill process dehulls the corn kernels by milling and fractures the endosperm, separating out the oil rich germ portion. The primary product is the degermed endosperm fraction as corn grits, meal, cones, and various flours. To prevent rancidity, the standard in the industry for dry milled products (grits, meal, flour) is typically between about 0.5% and 1% oil by weight.

The co-products from the dry fractionation process are the fibrous hull material and germ. The germ can be further processed to extract the oil by expellers or solvent extraction. Dry mills usually sell the germ to oil processors because the quantity available does not meet the economy of scale needed for oil recovery by solvent (hexane) extraction facilities.

In certain embodiments, the dry milling operation is preferable to wet milling described in the prior art because the germ from dry-milling (1) is milled finer, (2) removes microbial issues that are inherent in wet milling, (3) does not restrict the solids level of the wet slurry, and (4) will not denature the protein by foaming that is inherent in wet milling, thus affecting final product applications.

Corn protein can be described and classified by the location in the kernel—endosperm proteins are primarily comprised of water insoluble zein proteins and the germ proteins composed of between about 70% and 80% water soluble proteins (albumins and globulins). The functionality and fragility of these proteins are distinct.

Zein proteins are fairly unreactive in food systems that require water solubility. The zein proteins are alkali and alcohol (ethanol, iso-propanol) soluble and resistant to heat and pressure. Zein proteins are nutritionally deficient in lysine and other amino acids.

Unlike the water insoluble zein proteins in the endosperm, 70-80% of the total protein in corn germ is water soluble, meaning it can be extracted using water. (Watson, S. in Corn: Chem. & Tech., 2003). The germ proteins are highly nutritive, having an amino acid composition and protein efficiency rating (PER) equivalent to egg whites (Zayas and Lin, 1989).

These germ proteins are comprised of albumin and globulins and are sensitive to heat and mechanical denaturation. And, like other albumins and globulins, they are denatured—lose functionality such as water absorption—at acidic pH (pKa of about 4.5) and temperatures around 122° F.

Mechanical force such as expellers used to remove the oil from germ also denatures these proteins through mechanical energy converted to heat as well as shear forces generated in the process. Thus, to recover good yields of undenatured or functional germ protein, such conditions need to be avoided or minimized.

Since a high percentage of the germ protein is soluble in water, water is one technique that has been used to extract the germ protein from the germ fiber matrix. The germ needs to be defatted (oil removed), then milled and mixed with water to form a slurry to facilitate extraction of the protein. Full-fat germ from a dry milling operation contains oil at a concentration of between about 20% and 24% by weight.

If milled as full-fat germ, the product will “oil out’ and foul the mill. To facilitate milling to a granulation suitable for protein extraction (i.e.—U.S. 40 mesh or finer), the germ needs to have been substantially defatted. In certain embodiments, the defatted germ has an oil concentration of less than about 5% by weight. This is due to both the generation of heat and smearing of the oil by its natural lubricity.

Corn germ protein concentrates and isolates for use in food grade products are not presently an item of commerce due to the required economies of scale for oil extraction and the difficulty of obtaining the protein yield and purity for food applications. In addition, wet milling processes may cause inherent fouling of the protein, impact functionality and reduce yield due to sulfur dioxide, pH parameters and acidic pH soluble protein leaching into the steepwater.

Thus, the issues of recovery of the nutritious and palatable germ proteins require a technical approach not heretofore described. In addition, food proteins generally are of highest value for use in products in which the protein content is high such as greater than about 70% by weight.

Freeman et al., U.S. Pat. No. 3,615,655, utilize a coarse grind of less than a U.S. #20 sieve and depend upon abrasion and/or attrition wet milling of the slurry to free the protein from the germ matrix. Germ ground to this specification (<20 mesh) reduces yields and leaves a large amount of protein unextracted in the coarse pieces. In Example VI, Freeman indicates that the yield of the total germ protein by the hexane slurry method is only about 36%.

Freeman et al. did not use the water solubility of the germ proteins as a basis for recovery. Instead, after wet (aqueous) abrasion/attrition treatments, they separated the protein based upon the smaller particle size of the germ proteins using fine screens or bolting cloth to facilitate recovery of the proteins. Freeman et al. contend in their patent that the abrasion/attrition treatment disrupted the small germ proteins from the germ matrix.

Fine mesh screens were only used to recover the protein after attrition milling; otherwise they separated the germ cake by centrifugation. In addition, Freeman utilized expellers and steam stripping of the solvent (hexane) in the examples of that patent, both of which are known to denature the proteins. Denaturation limits the functional use of the proteins in food systems as well as decreases their nutritional value (Zayas and Lin, 1989).

Freeman reported very low yields for these processes—“36 percent of the original protein present” for the hexane method in Example VI of Freeman, and a purity of only 59.5% in Table IV in Freeman. Freeman's water slurry method reports even lower purity (36.9%) and yield in Table II of Freeman. These yields and purities are economically unattractive. The process of Freeman and Olson does not lend itself to reduction to practice in a commercial operation because of the yields and purity.

### SUMMARY OF THE INVENTION

An embodiment of the invention is directed to a method for extracting corn germ proteins, which after extraction may be used in food products. When used in conjunction with an ethanol production facility, the corn germ protein extraction process creates another revenue stream while reducing the low value products generated as part of the ethanol production process.

An aqueous extraction to recover the soluble corn germ protein is described. High yield extraction (83-90%+) of corn germ soluble protein is obtained using ultra-fine milled (<200 mesh), defatted corn germ, slurried with water at a temperature of between about 40° F. and 50° F. at a total solids level of between about 15% and 30% at a pH of about 6.3 using calcium at a concentration of about 0.1% by weight of the slurry.

The slurry is mixed avoiding foaming for at least 15 minutes and then centrifuged. Next, the cake is re-suspended and alkali extracted at a pH of about 8.5 for at least 15 minutes. The alkali extracted cake is centrifuged and the cake re-suspended and extracted again at a pH of about 8.5. Additional alkali extractions can be made, especially with higher solids slurries to maintain high yields. A counter-current process may be used in which each successive alkaline decantant would be used to slurry the previous centrifuges cake to increase the protein level and improve the economics as compared to batch process extractions.

The decantants from the aqueous extractions are filtered with 1.0-10 micron membrane to remove residual germ particulates from the decantant prior to precipitation by acidic-ethanol at a weight to weight ratio of about 1:1 to recover the soluble germ protein. Alternatively, acid precipitation can be performed using hydrochloric acid at a pH of between about 4.5 and 3.5. Microfiltration and ultrafiltration methods may also be utilized on the decantants to concentrate and purify the protein prior to precipitation with either acid and or ethanol. The precipitate may be recovered by centrifugation.

Next, the protein cake may be washed with acidic ethanol and centrifuged. The cake may be spray dried and the ethanol recovered by evaporation. Alternatively, the ethanol precipitated cake may be slurried with water and spray dried. A protein yield of between about 83% and 90% of the soluble protein may be achieved with an average protein purity of about 82%. It is also possible to use these techniques to produce protein isolates comprised of greater than about 90% protein. The residual proteins in the acid whey stream may be recovered by microfiltration and ultrafiltration to further increase protein yield.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a graph of protein and total solids with respect to number of extractions.

FIG. 2 is a graph of pH with respect to protein extraction yield.

FIG. 3 is a graph of pH with respect to solubility of phytate and protein in corn germ.

FIG. 4 is a graph of phytate reduction by calcium.

### DETAILED DESCRIPTION OF THE PREFERRED EMBODIMENTS

The method described takes advantage of properties of the germ proteins within the germ structure to: (1) preserve the functional and nutritional aspects of the protein by careful control at each step to not denature the protein, (2) extract the valuable protein based upon physical properties such as water extractability and solubility of the germ proteins, (3) recover the proteins by methods that do not denature the proteins, and (4) recover the proteins at high concentration levels (i.e. greater than about 70% protein) and high yields of the soluble proteins (i.e. about 80 to 90%).

We found that a finer grind results in a higher extraction of the water extractible/soluble germ proteins. Defatted germ was milled using the finest setting on a Perten Laboratory Mill model 3600 that resulted in flour at approximately 20 mesh. This material was compared to a finer milled flour prepared using a Cyclotech lab mill (1 mm screen) and to a commercial ultra-fine milled product from a Pulvocron mill (Bepex Corp., Minneapolis, Minneapolis). It was found that the finer grinding produced an increase in yield of about 30% for the finer flours produced using the Cyclotech and Pulvocron mills versus the coarse flour produced using the Perten mill.

We further compared flour milled using a Cyclotech mill having a 0.5 mm screen. The resulting flour was then sieved to <100 mesh to that from the Pulvocron mill at <200 mesh (Table 1). Each of the samples had a total solids concentration of 15%. A comparison of soluble protein levels from decantants of aqueous extractions at pH 7, 8, and 9 showed an increase from approximately 20 to 27% for the finer Pulvocron milled defatted germ.

TABLE 1

| | Soluble protein | | |
|---|---|---|---|
| | in extract (%) | Soluble protein in extract | Increase in |
| pH | using <100 U.S. mesh | (%) using <200 U.S. mesh | Protein (%) |
| 7 | 1.86 | 2.30 | 23.66 |
| 8 | 2.43 | 2.91 | 19.75 |
| 9 | 2.54 | 3.23 | 27.17 |

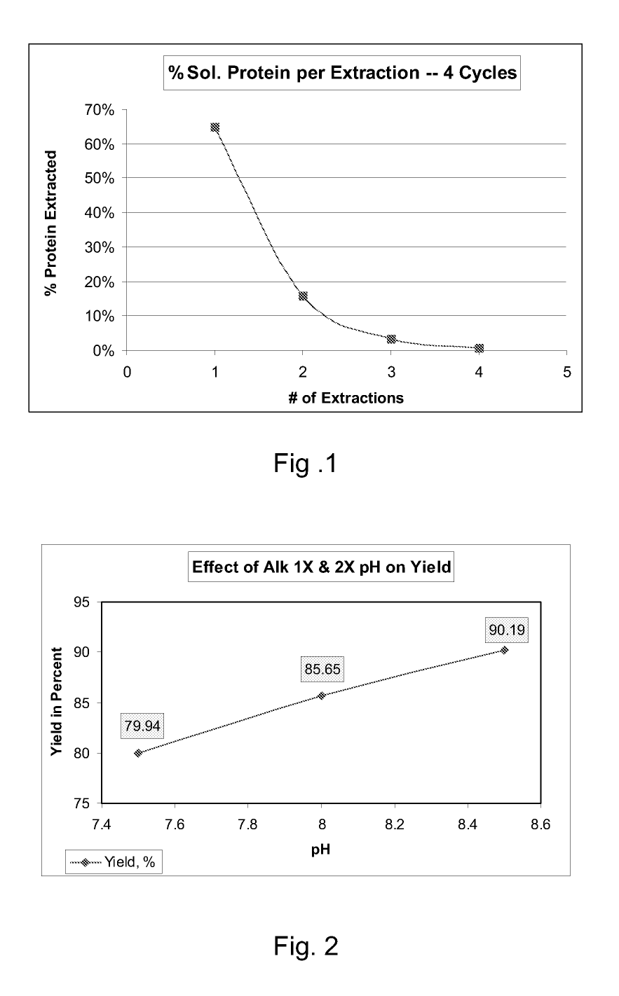

In our work, yield was determined by extracting the soluble proteins in the germ to exhaustion. FIG. 1 shows the results of the method using a series of four extractions on a 15% solids aqueous slurry of defatted, fine milled corn germ at a pH of about 9.0, separating the cake by centrifuging between extractions, removing all of the soluble protein. Using this method, our results showed that an average of about 80% of the total protein was water-extractible/soluble, which agrees well with that of the literature (Lawton, in Corn: Chem. & Tech., 2003). This value was used to calculate the percentage yield of the process.

Protein yield and purity were determined by precipitation of the soluble protein from the centrifuged decantant using ethanol and acid (hydrochloric acid). Precipitation by ethanol occurred when an equal weight of anhydrous ethanol was added to the decantant. The protein forms a white flocculant material that is easily separated by centrifugation (greater than 1,500×g).

Ethanol precipitation is a reversible protein denaturation while acid precipitations such as trichloroacetic acid (TCA) or HCl are usually irreversible protein denaturations. The difference is the recovery of the protein conformation and functionality once restored in water (reversible denaturation). Heating during precipitation by either acid or ethanol will irreversibly denature most proteins.

We found that ethanol would recover greater than 85% of the intact protein from the decantant as a precipitant. The protein content of the precipitate was then determined by standard protein analysis (kjeldahl) and the total solids determined as well. Yield was calculated by dividing the total protein recovered in the precipitate by the total soluble protein in the germ per the 4 cycle extraction. Purity was calculated by dividing the protein content by the total solids.

Recovery by acid precipitation was also demonstrated using HCl as the most common food grade acid for this purpose. Adjusting the pH of the decantant to a pH equal to or slightly below the pKa of the germ proteins (pH 4.5-4.7) resulted in a high purity precipitate. However, acid precipitation also resulted in protein hydrolysis, even at these relatively mild conditions. Yield as a precipitant was reduced by up to about 30% (Table 2). The remaining protein was in the ‘whey’ as hydrolysis products and could be accounted for by analyzing for protein.

TABLE 2

| Extractions at 15% solids | |
|---|---|
| corn germ slurry | Yield, % of Theoretical |
| Fine germ flour pH 7 extract, EtOH ppt | 86.80 |
| Fine germ flour pH 8 extract, EtOH ppt | 85.30 |
| Fine germ flour pH 9 extract, EtOH ppt | 90.50 |
| Fine germ flour pH 7 extract, HCl ppt | 62.60 |
| Fine germ flour pH 8 extract, HCl ppt | 74.40 |
| Fine germ flour pH 9 extract, HCl ppt | 65.10 |

The fragile nature of the germ enzyme proteins resulted in only the larger, intact proteins precipitating. The majority of the protein in the whey can be recovered by ultrafiltration and ethanol precipitation. Further, the acid precipitated protein product was denatured and would not readily re-solubilize in water after neutralizing the pH, whereas the ethanol precipitate would absorb water and solubilize/re-suspend.

Like many proteins such as protein derived from soy, corn germ protein has greater solubility at an alkali pH (greater than pH 7.0). Soy protein can be extracted to high levels of purity such as greater than about 90% using an alkali aqueous extraction at temperatures of up to about 176° F. Soy protein extraction and yield is improved at higher pH of about 9 yields more protein than the extraction performed at a pH of about 7.5. Yields for soy continue to improve when performed at a pH of about 9. However, some nutritional losses occur due to interactions of amino acids, and increased discoloration occurs due to Maillard reaction products.

Unlike soy proteins, corn germ proteins are more sensitive to heat and heat/alkali reactions. The germ albumin and globulin proteins are largely the enzymes (proteins) needed for sprouting or “germination” and are much more susceptible to denaturation and loss of functionality due to temperature, pH or shear forces. The extraction process and the recovery processes for corn germ protein must take these factors into account relative to quality and yield.

For example, we have found that alkali extraction from a neutral pH up to a pH of about 9.0 showed increasing yields with pH. We also found that increasing pH of greater than about 7.0 increased the amount of germ pigments (carotenoids) co-extracted, which affects the color quality of the resulting protein product. Therefore, the pH was maintained below about 9.0 (FIG. 2).

Unlike soy, we found that higher temperatures did not increase yields for corn germ protein. Extractions and yields were the same when performed at a temperature of between about 73° F. and 86° F. or at refrigeration temperatures of about 40° F. In light of the preceding comments, the extraction is carried out under ‘cold’ conditions of between about 40° F. and 50° F., which has a number of advantages relative to the microbial control in the process.

The extraction process is relatively quick—often being completed in less than 20 minutes per cycle. Fine milled (<200 mesh), defatted germ is slurried with cold water (between about 40° F. and 50° F.) at solids levels up to about 30% by weight, the pH is adjusted to about 8.5 and mixed for about 15 minutes, avoiding formation of foam. The maximum slurry solids level is limited by the viscosity. The slurry is then centrifuged on a centrifuge at 1,700-2,550×g to obtain a decantant containing the aqueous solubilized extraction of the germ protein. This process comprises one extraction cycle. The protein in the combined decantant from the two extraction cycles will achieve a yield of between about 83% and 90% for a germ slurry having a solids concentration of about 15% by weight.

To maintain the same high extraction yields, increased solids level require an increased number of alkali slurry cycles. Thus, as one moves from a 15% solids slurry to a 25% solids slurry, the number of alkali extraction cycles for maintaining yield may be increased from 2 to 4, respectively. The number of cycles is directly related to the cost of the gain in yield per extraction cycle.

The extracted slurry is then centrifuged by conventional means at greater than 1,500×g. The decantant is collected and an equal weight of anhydrous ethanol added, mixed and allowed to precipitate for at least about 15 minutes. We found that a higher purity product (protein content) was obtained by acidifying the ethanol—decantant mix to a pH of between about 6.3 and 6.5 using dilute HCl. Protein content increased from between about 65% and 69% to about 80%. This acid-ethanol procedure also resulted in a whiter product.

The precipitated protein is then collected by centrifugation. The precipitated cake is washed with ethanol using 2 times the weight of the cake with mixing to re-suspend the cake in the ethanol. It is held a second time for at least 15 minutes at a pH of between about 6.3 and 6.5, centrifuged and spray dried. The second ethanol wash removes lipids and other contaminants that reduce the protein purity and results in a whiter product upon spray drying.

Alternatively, the ethanol washed cake can be re-suspended in water and spray dried. Acid precipitation can be performed, noting the reduction in precipitate per Table 2. The remaining protein is reclaimed by microfiltration and ultrafiltration separation using a suitable membrane of between about 5 kDa and 10 kDa for ultrafiltration.

The removal of phytate is an important process step to improve the protein purity of the corn germ protein extract. Corn germ contains phytate or phytic acid as the major storage form of organic phosphate. Phytate is about 86% phosphate and can bind minerals, fiber, and proteins due to its negative charge. Phytate is highly soluble at acidic pH and virtually insoluble at alkali pH.

Removal of phytate is desired for both functional as well as nutritional reasons. Soy protein processes can take advantage of phytate's acid solubility since soy proteins retain functionality after acidic treatments or acid precipitation. However, an acidic precipitation without downstream recovery of the protein in the whey will result in a dramatic loss in protein yield.

Removal of phytate from the extraction is desirable due to the various states in which protein may interact, thereby decreasing both yield and purity of the germ protein. Phytate can bind directly to positive charged terminal amino acids on the protein molecule and affect the protein solubility. We noted a protein purity threshold of about 65-69% protein (dry basis) from ethanol precipitates using only alkali (pH 8-9) extractions. High ash content was the other primary component.

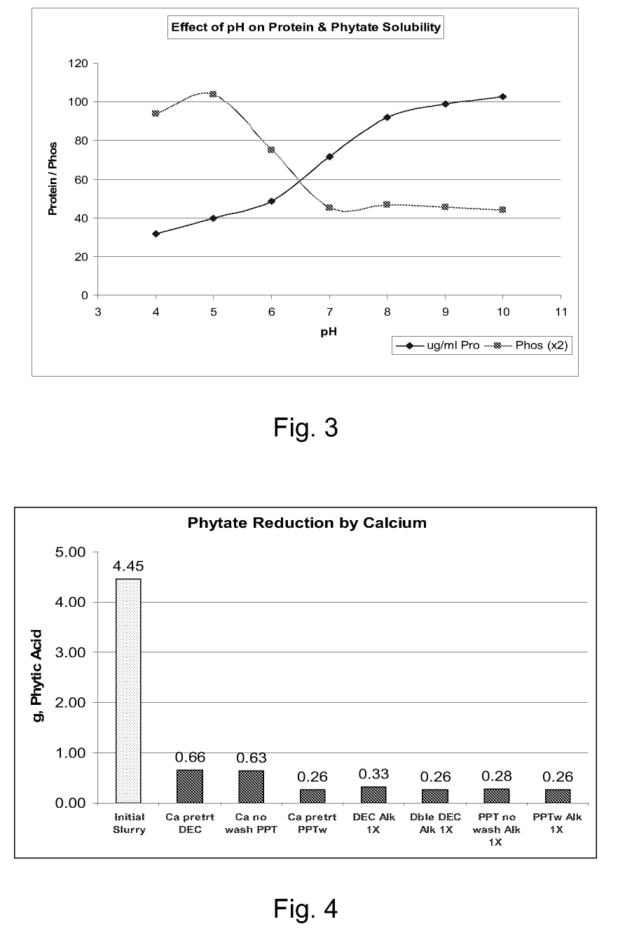

While both defatted soy and corn germ flour show phytate soluble at low pH (pH less than 4), phytate in corn germ is insoluble at higher pH whereas phytate in defatted soy flour increases in solubility at neutral and alkali pH. This is similar to the solubility of phytate in rice bran. FIG. 3 shows the relationship between phytate and protein solubilities relative to pH for defatted corn germ.

We found that using 0.1% CaCl₂ in a pre-extraction step (also at cold temperature) at a pH of about 6.3 reduced the soluble phytate content of a 15% solids slurry by 75%, from 4.125 g/L to 1.075 g/L. Using this pretreatment step prior to the alkali extraction cycles resulted in improved protein purity up to 90% protein and 82% protein (on average) by ethanol precipitation. Yield remained at between about 83% and 90% recovery of total soluble protein.

Calcium pre-treatment extractions performed at a pH of lower than about 6.3 such as between about 5.0 and 5.5 resulted in yields reduced to about 64% of theoretical and purity to about 40% protein in the pre-treatment step. Further, upon the subsequent alkali extractions, extreme color would develop to a dark grey, presumably from color reactions due to the acidic treatment which developed under alkali conditions.

Color of the final protein product was also darkened, an undesired result. Addition of calcium directly to the alkali extractions (pH 7 or greater) produced reduced yields as did increased calcium content greater than 0.1% CaCl₂ (360 ppm Ca++). The calcium treatment was most effective as a pretreatment rather than a post-extraction treatment.

For example, the same result could not be obtained by treating the extracted decantant as was obtained when treating the initial extraction slurry at a pH of about 6.3. This result is probably due to phytate-protein bonds that occur at low pH. At neutral to mild alkali pH, a phytate-cation-protein bonding is formed.

Calcium pre-treatment circumvents this issue by directing calcium-phytate binding via pH control. A pH of about 6.3 appears to coincide with a point in the solubility curve where the solubility of the phytate is low but not insoluble and the protein is substantially increasing in solubility, as illustrated in FIG. 3.

This result would reflect a change in charge for both components at this point, with less binding of the protein by the phytate in favor of the divalent calcium cation, and, an increasing reduction of positively charged terminal amino acids such as arginine, lysine, and histidine as the pH increases. Conformational changes in the proteins caused by increasing pH and resulting in increased water solubility would also affect protein binding potential.

Since calcium phytate is insoluble at alkali pH there is less likelihood of a phytate-cation-protein bond with increasing pH in the presence of calcium. The insoluble calcium-phytate would precipitate upon separation by centrifuge while the alkali soluble protein would remain in the decantant, thereby decreasing phytate associated with the recovered protein from the decantant.

With the 75% reduction of phytate in the corn germ slurry, the effect of the calcium pretreatment was followed using direct phytic acid analysis (HPLC). FIG. 4 shows the reduction of the amount of phytate in the initial slurry and the resulting amount in the recovered protein precipitate (all on a dry basis). PPT indicates acidic ethanol precipitate and PPTw indicates acidic ethanol wash. The protein content for the acidic alcohol precipitant (dry basis) was 90% or higher protein.

The protein product resulting from the mild treatments of the extraction process as described herein result in a nutritional content very similar to egg whites. Table 3 compares the amino acid profile for the corn germ soluble protein product to that of egg whites. In some cases—glycine & arginine—the value is almost double. The data for egg whites was obtained from USDA Nutrient Database for Standard Reference, Release #21 (2008).

TABLE 3

| Amino | Average, a.a. | USDA Ref. | Germ protein as |
|---|---|---|---|
| Acid | Germ Extract | Egg Whites | % of Egg Whites |
| Asp | 7.28 | 8.25 | 88.24% |
| Thr | 4.14 | 3.68 | 112.52% |
| Ser | 4.68 | 5.59 | 83.67% |
| Glu | 14.62 | 10.77 | 135.75% |
| Pro | 3.50 | 3.15 | 111.04% |
| Gly | 5.43 | 2.84 | 191.21% |
| Ala | 5.84 | 4.68 | 124.73% |
| Val | 4.67 | 5.16 | 90.53% |
| Iso-leu | 3.18 | 4.58 | 69.40% |
| Leu | 6.21 | 6.84 | 90.75% |
| Tyr | 2.90 | 3.15 | 92.06% |
| Phe | 3.96 | 4.74 | 83.62% |
| Lys | 5.58 | 5.52 | 101.15% |
| His | 2.52 | 1.83 | 137.65% |
| Arg | 9.66 | 4.41 | 218.97% |
| Cys | 2.34 | 2.1 | 111.52% |
| Met | 0.46 | 2.79 | 16.36% |
| Trp | 1.28 | 1 | 128.08% |

The protein product from the dry mill application of the process described herein would warrant an increased value due to its properties such as the above excellent amino acid content for nutritional uses as a valuable protein supplement for health foods like infant formula and medical food supplements (beverage or foods). It would be expected to sell at a price competitive to and approximate to soy, dairy or egg protein.

Such revenue would greatly bolster and add to the corn industries margins. Further applications from different protein modifications known in the art (Haard, F. Chpt 7. Enzymic Modifications of Proteins in Food Systems. In, Sikorski, CRC Press, 2001) are anticipated for functional applications of water binding, beverage grade solubility, gelation, increasing volume in baking, whipping, and other common uses of high protein ingredient applications similar to dairy and egg whites.

While the description herein utilizes the dry mill corn process, it is clear that any corn process wherein the germ is separated or partially separated as a result of the process would allow protein extraction by the method described. These applications would be apparent to anyone skilled in the art. Thus, wet mill corn processes which separate the germ can extract the soluble or water extractable proteins using this method.

Considerations mentioned herein anticipate the issues of any chemical or fermentation compounds that would reduce the yield, purity, functionality or palatability of the end-product. This would apply to processes such as whole kernel milled corn used in the fuel ethanol process which could separate germ fractions at several points in the process after milling and result in a germ containing fraction which could be extracted by the process described herein. It is anticipated that the product results would vary in qualities but would be of economic value.

It is contemplated that features disclosed in this application, as well as those described in the above applications incorporated by reference, can be mixed and matched to suit particular circumstances. Various other modifications and changes will be apparent to those of ordinary skill.

1. A process for extraction of edible protein from corn germ comprising:
providing a defatted corn germ with a fat concentration of less than about 5% by weight;
milling the corn germ to a granulation of less than about 100 US mesh at less than 180° F.;
preparing an aqueous slurry from the milled corn germ; and
extracting an edible protein solution from the aqueous slurry.

2. The process of claim 1, wherein protein in the defatted corn germ is substantially non-denatured.

3. The process of claim 1, wherein the defatted corn germ is milled to a granulation of less than about 200 US mesh.

4. The process of claim 1, wherein the milling is performed at a temperature of less than about 130° F.

5. The process of claim 1, wherein the aqueous slurry has a solids content of up to about 30% by weight.

6. The process of claim 1, wherein the extraction is performed at a temperature of less than about 60° F.

7. The process of claim 1, wherein the extraction is performed for at least 15 minutes and wherein foaming is avoided during the extraction.

8. The process of claim 1, and further comprising:
pretreating the aqueous slurry with a calcium addition, wherein a concentration of calcium in the calcium addition is between about 0.03 and 0.054 percent by weight of the aqueous slurry; and
adjusting a pH of the aqueous slurry to between about 6.3 and 7.0.

9. The process of claim 1, and further comprising centrifuging the aqueous slurry to recover a first decantant and a first cake, wherein the first decantant contains a water extractable protein.

10. The process of claim 9, and further comprising:
re-suspending the first cake in water to form a first cake slurry;
adjusting a pH of the first cake slurry to greater than 8.0;
mixing the first cake slurry for at least 15 minutes; and
centrifuging the first cake slurry to recover a second decantant and a second cake.

11. The process of claim 10, and further comprising:
re-suspending the second cake in water to form a second cake slurry;
adjusting a pH of the second cake slurry to greater than 8.0;
mixing the second cake slurry for at least 15 minutes; and
centrifuging the second cake slurry to recover a third decantant and a third cake.

12. The process of claim 11, and further comprising recovering the edible protein using acidic-ethanol precipitation from at least one of the first decantant, the second decantant and the third decantant to produce an ethanolic precipitated protein.

13. The process of claim 12, and further comprising:
re-suspending the ethanolic precipitated protein with water and spray drying this suspension.

14. The process of claim 12, and further comprising:
adding water to at least one of the first decantant, the second decantant and the third decantant at a ratio of about 1:1 of a total weight of the first decantant, the second decantant and the third decantant to prepare an ethanolic-decantant solution;
adjusting a pH of the aqueous decantant solution to between about 6.3 and 7.0;
mixing the aqueous decantant solution for at least 15 minutes;
centrifuging the aqueous decantant solution to recover a precipitated edible protein;
washing the precipitated edible protein by resuspension of the precipitated protein with water at a ratio of 2:1 by weight of water to precipitate;
centrifuging and recovering the precipitated protein; and
spray drying the precipitated protein to produce an edible protein composition, wherein the edible protein composition is at least 80% by weight protein.

15. The process of claim 1, wherein greater than about 80% of protein in the defatted corn germ is recovered.

16. A process for extraction of edible protein from corn germ comprising:
providing a defatted corn germ with a fat concentration of less than about 5% by weight;
preparing an aqueous slurry from the defatted corn germ; and
extracting an edible protein solution from the aqueous slurry at a temperature of less than 60° F.

17. The process of claim 16, wherein protein in the defatted corn germ is substantially non-denatured.

18. The process of claim 16, and further comprising milling the defatted corn germ to a granulation of less than about 100 US mesh at a temperature of less than about 180° F.

19. The process of claim 16, wherein the aqueous slurry has a solids content of up to about 30% by weight.

20. The process of claim 16, wherein the extraction is performed at a temperature of between about 40° F. and 50° F.

21. The process of claim 16, wherein the extraction is performed for at least 15 minutes and wherein foaming is avoided during the extraction.

22. The process of claim 16, and further comprising:
pretreating the aqueous slurry with a calcium addition, wherein a concentration of calcium in the calcium addition is between about 0.03 and 0.054 percent by weight of the aqueous slurry; and
adjusting a pH of the aqueous slurry to between about 6.3 and 7.0.

23. The process of claim 16, and further comprising centrifuging the aqueous slurry to recover a first decantant and a first cake, wherein the first decantant contains a water extractable protein.

24. The process of claim 23, and further comprising:
re-suspending the first cake in water to form a first cake slurry;
adjusting a pH of the first cake slurry to greater than 8.0;
mixing the first cake slurry for at least 15 minutes; and
centrifuging the first cake slurry to recover a second decantant and a second cake.

25. The process of claim 24, and further comprising:
re-suspending the second cake in water to form a second cake slurry;
adjusting a pH of the second cake slurry to greater than 8.0;
mixing the second cake slurry for at least 15 minutes; and
centrifuging the second cake slurry to recover a third decantant and a third cake.

26. The process of claim 25, and further comprising recovering the edible protein using acidic-ethanol precipitation from at least one of the first decantant, the second decantant and the third decantant.

27. The process of claim 26, and further comprising:
adding anhydrous alcohol to at least one of the first decantant, the second decantant and the third decantant at a ratio of about 1:1 of a total weight of the first decantant, the second decantant and the third decantant to prepare an ethanolic-decantant solution;
adjusting a pH of the ethanolic-decantant solution to between about 6.3 and 7.0;
mixing the ethanolic-decantant solution for at least 15 minutes;
centrifuging the ethanolic-decantant solution to recover a precipitated edible protein;
washing the precipitated edible protein by resuspension of the precipitated protein with acidic ethanol at a ratio of 2:1 by weight of ethanol to precipitate;
centrifuging and recovering the precipitated protein; and
spray drying the precipitated protein to produce a precipitated protein, wherein the precipitated protein is at least 80% by weight protein.

28. The process of claim 27, and further comprising:
re-suspending the precipitated protein with water and spray drying this suspension.

29. The process of claim 27, and further comprising:
adding an acid to at least one of the first decantant, the second decantant and the third decantant to prepare an acid-decantant solution;
adjusting a pH of the acid-decantant solution to between about 3.5 and 4.5;
stirring the aqueous acid-decantant solution for at least 15 minutes;
centrifuging the aqueous decantant solution to recover a precipitated edible protein;
ultrafiltrating acid precipitate decantant to recover any protein remnants from that stream;
adjusting the pH of the precipitated edible protein to about 7.0; and
spray drying the precipitated protein to produce an edible protein composition, wherein the edible protein composition is at least 80% by weight protein.

30. The process of claim 27, and further comprising:
ultrafiltering the first decantant to prepare a first edible protein concentrate;
ultrafiltering the second decantant to prepare a second edible protein concentrate;
ultrafiltering the third decantant to prepare a third edible protein concentrate; and
spray drying to prepare a first edible protein concentrate, to prepare a second edible protein concentrate and to prepare a third edible protein concentrate to produce an edible protein composition, wherein the edible protein composition is at least 80% by weight protein.

31. The process of claim 16, wherein greater than about 80% of water extractible/soluble protein in the defatted corn germ is recovered.

32. A process for extraction of edible protein from corn germ comprising:
providing a defatted corn germ with a fat concentration of less than about 5% by weight;
preparing an aqueous slurry from the defatted corn germ;
pretreating the aqueous slurry with a calcium solution; and
extracting an edible protein solution from the pretreated aqueous slurry.

33. The process of claim 32, wherein protein in the defatted corn germ is substantially non-denatured.

34. The process of claim 32, and further comprising milling the defatted corn germ to a granulation of less than about 100 US mesh at a temperature of less than about 180° F.

35. The process of claim 32, wherein the aqueous slurry has a solids content of up to about 30% by weight.

36. The process of claim 32, wherein the extraction is performed at a temperature of less than about 60° F. for at least 15 minutes and wherein foaming is avoided during the extraction.

37. The process of claim 32, wherein the calcium solution comprises calcium chloride, wherein a concentration of the calcium chloride is between about 0.08 and 0.15 percent by weight of the aqueous slurry and wherein a pH of the aqueous slurry is adjusted to between about 6.3 and 7.0.

38. The process of claim 32, and further comprising centrifuging the aqueous slurry to recover a first decantant and a first cake, wherein the first decantant contains a water extractable protein.

39. The process of claim 38, and further comprising:
re-suspending the first cake in water to form a first cake slurry;
adjusting a pH of the first cake slurry to greater than 8.0;
mixing the first cake slurry for at least 15 minutes; and
centrifuging the first cake slurry to recover a second decantant and a second cake.

40. The process of claim 39, and further comprising:
re-suspending the second cake in water to form a second cake slurry;
adjusting a pH of the second cake slurry to greater than 8.0;
mixing the second cake slurry for at least 15 minutes; and
centrifuging the second cake slurry to recover a third decantant and a third cake.

41. The process of claim 40, and further comprising recovering the edible protein using acidic-ethanol precipitation from at least one of the first decantant, the second decantant and the third decantant.

42. The process of claim 41, and further comprising:
adding anhydrous alcohol to at least one of the first decantant, the second decantant and the third decantant at a ratio of about 1:1 of a total weight of the first decantant, the second decantant and the third decantant to prepare an ethanolic-decantant solution;
adjusting a pH of the ethanolic-decantant solution to between about 6.3 and 7.0;
mixing the ethanolic-decantant solution for at least 15 minutes;
centrifuging the ethanolic-decantant solution to recover a precipitated edible protein;
washing the precipitated edible protein by resuspension of the precipitated protein with acidic ethanol at a ratio of 2:1 by weight of ethanol to precipitate;
centrifuging and recovering the precipitated protein; and
spray drying the precipitated protein to produce an edible protein composition, wherein the precipitated protein composition is at least 80% by weight protein.

43. The process of claim 41, and further comprising:
re-suspending the precipitated protein with water and spray drying this suspension.

44. The process of claim 32, wherein greater than about 80% of protein in the defatted corn germ is recovered.

45. A process for extraction of edible protein from corn germ comprising:
providing a defatted corn germ with a fat concentration of less than about 5% by weight;
preparing an aqueous slurry from the defatted corn germ;
extracting an edible protein solution from the aqueous slurry;
centrifuging the edible protein solution to prepare a decantant and
recovering the edible protein from the decantant using acidic ethanol precipitation.

46. The process of claim 45, wherein protein in the defatted corn germ is substantially non-denatured.

47. The process of claim 45, and further comprising milling the defatted corn germ to a granulation of less than about 100 US mesh, wherein the milling is conducted at a temperature of less than about 180° F.

48. The process of claim 45, wherein the aqueous slurry has a solids content of up to about 30% by weight.

49. The process of claim 45, wherein the extraction is performed at a temperature of less than about 60° F. for at least 15 minutes and wherein foaming is avoided during the extraction.

50. The process of claim 45, and further comprising:
pretreating the aqueous slurry with a calcium addition, wherein a concentration of calcium in the calcium addition is between about 0.03 and 0.054 percent by weight of the aqueous slurry; and
adjusting a pH of the aqueous slurry to between about 6.3 and 7.0.

51. The process of claim 45, and further comprising centrifuging the aqueous slurry to recover a first decantant and a first cake, wherein the first decantant contains a water extractable protein.

52. The process of claim 51, and further comprising:
re-suspending the first cake in water to form a first cake slurry;
adjusting a pH of the first cake slurry to greater than 8.0;
mixing the first cake slurry for at least 15 minutes; and
centrifuging the first cake slurry to recover a second decantant and a second cake.

53. The process of claim 52, and further comprising:
re-suspending the second cake in water to form a second cake slurry;
adjusting a pH of the second cake slurry to greater than 8.0;
mixing the second cake slurry for at least 15 minutes; and
centrifuging the second cake slurry to recover a third decantant and a third cake.

54. The process of claim 53, and further comprising recovering the edible protein using acidic-ethanol precipitation from at least one of the first decantant, the second decantant and the third decantant.

55. The process of claim 54, and further comprising:
adding anhydrous alcohol to at least one of the first decantant, the second decantant and the third decantant at a ratio of about 1:1 of a total weight of the first decantant, the second decantant and the third decantant to prepare an ethanolic-decantant solution;
adjusting a pH of the ethanolic-decantant solution to between about 6.3 and 7.0;
mixing the ethanolic-decantant solution for at least 15 minutes;
centrifuging the ethanolic-decantant solution to recover a precipitated edible protein;
washing the precipitated edible protein by resuspension of the precipitated protein with acidic ethanol at a ratio of 2:1 by weight of ethanol to precipitate;
centrifuging and recovering the precipitated protein; and
spray drying the precipitated protein to produce an edible protein composition, wherein the edible protein composition is at least 80% by weight protein.

56. The process of claim 45, wherein greater than about 80% of protein in the defatted corn germ is recovered.

57. The process of claim 53, wherein the process is continuous and countercurrent by adding water to re-suspend the third cake and using that decantant to re-suspend the cake from the second extraction so that the decantant exiting the first alkali extraction is now a combined second and third decantant from the two alkali treatments.
